(19) United States
(12) Patent Application Publication
(10) Pub. No.: US 2009/0051619 A1
(43) Pub. Date: Feb. 26, 2009

(54) ARRAY ANTENNA WITH ENHANCED SCANNING

(76) Inventors: Anders Hook, Hindas (SE); Joakim Johansson, Tollsjo (SE); Mats Gustafsson, Malmo (SE)

Correspondence Address: ERICSSON INC., 6300 LEGACY DRIVE, M/S EVR 1-C-11, PLANO, TX, 75024, US

(21) Appl. No.: 12/097,863

(22) PCT Filed: Dec. 23, 2005
(86) PCT No.: PCT/SE2005/002030

§ 371 Date: Jun. 17, 2008

(51) Int. Cl. H01Q 21/06

(52) U.S. Cl. 343/893

(57) ABSTRACT

The invention provides an improved array antenna, an array antenna system and an improved method for utilizing the improved array antenna and array antenna system. This is accomplished by an array antenna comprising a region of reference potential, e.g. a ground plane, and a spatially extended collection of at least two antenna elements capable of being at least partly balanced driven and at least partly unbalanced driven. The antenna elements have a first radiating element connected to a first port and a second radiating element connected to a second port. In other words, the antenna element has at least two ports. The radiating elements are arranged substantially adjacent and parallel to each other so as to extend at least a first distance approximately perpendicularly from said region of reference potential. The antenna element is further comprising a radiating arrangement connected to said first and said second radiating elements so as to extend at least a second distance above and approximately parallel to said region of ground reference.

### FIELD OF THE INVENTION

The present invention relates to an array antenna for transmitting and receiving electromagnetic radiation and more particularly to an array antenna with an enhanced ability of steering the antenna lobe, especially the antenna lobe direction.

### BACKGROUND OF THE INVENTION

Array antennas and particularly phased controlled array antennas have become increasingly attractive, not only for military applications but also for civil and commercial applications. Array antennas can be advantageously utilized in radar systems, in radio telescopes or in so-called base stations in a wireless telecommunication network etc. One of the most favourable properties of an array antenna and particularly a phased controlled array antenna is the increased ability to dynamically and very quickly re-forming and/or re-directing the antenna lobe.

In particular, this can be utilized to avoid transmitting and/or receiving interference signals to and from neighbouring transmitters and/or receivers. In many cases the antenna lobe can be formed and/or directed to avoid receiving and/or transmitting such disturbances. In radar systems this ability can e.g. be used to avoid hostile jamming sources. In cellular telecommunication system or similar this ability can e.g. be used to enhance the utilization of the available frequency spectrum, e.g. the frequency spectrum in a GSM-system, a CDMA-system, a WCDMA-system or other similar radio communication systems. This is only examples of applications. There is a vast spectrum of different applications, as is well-known.

The ability to dynamically and very quickly re-forming and/or re-directing the antenna lobe is also advantageous in that the antenna lobe can be directed to transmit and/or receive electromagnetic radiation to and/or from a small geographical area, which increases the energy efficiency of the antenna system. These and other advantages provided by array antennas and particularly by phased controlled array antennas are well-known in the art of array antennas and they need no further explanation.

An array antenna is basically a spatially extended collection of several substantially similar antenna elements. The expression “spatially extended” implies that each element has at least one neighbouring element that is placed at a close distance so as to avoid emission of electromagnetic radiation in ambiguous directions. The expression “similar” implies that preferably all elements have the same polar radiation patterns, orientated in the same direction in 3-d space. However, the elements do not have to be spaced on a regular grid, neither do they have to have the same terminal voltages, but it is assumed that they are all fed with the same frequency and that one can define a fixed amplitude and phase angle for the drive signal of each element.

By adjusting the relative phases of the respective signals feeding the antenna elements in an array antenna the effective radiation pattern (the antenna lobe) of the antenna can be reinforced in a desired direction and suppressed in undesired directions. The relative amplitudes of, and constructive and destructive interference effects among, the signals radiated by the individual antenna elements determine the effective radiation pattern of the array antenna. An ordinary array antenna can be used to accomplish a fixed radiation pattern (fixed antenna lobe), whereas a more sophisticated phase controlled array antenna can be used to rapidly scan the radiation pattern (the antenna lobe) in azimuth and/or elevation.

However, depending on the individual antenna elements chosen for the array antenna in question there is formally at least one direction in which the antenna lobe cannot be readily directed, i.e. there is at least one null point.

The individual antenna elements in an array antenna can e.g. be the well-known dipole 10 or similar, as schematically illustrated in FIGS. 1A-1D. The exemplifying dipole 10 in FIG. 1A comprises two opposite radiating elements 11a, 11b. The radiating elements 11a, 11b are preferably shaped as elongated threads, cylinders or rectangles so as to extend ¼ (λ/4) of the utilized wavelength along a horizontal axis DPI. Each radiating element 11a, 11b is individually connected to a feeding line 12a, 12b in a well-known manner for communicating high frequency signals to and from the dipole 10. Hence, formally the dipole 10 comprises two ports. One usually considers the balanced (or differential mode) current I_{diff}=(I₁−I₂)/2 to be the current that excites the dipole, where the power conveyed by I_{diff} is supposed to convert to transmitted electromagnetic power. The differential mode is illustrated in FIG. 1A by a first current I₊ fed to the first feeding line 12a (the first port) and a second current I₋ fed to the second feeding line 12b (the second port). The two currents I₊, I₋ are of substantially equal magnitude but provided with opposite suffixes to indicate that they are out of phase by 180°, i.e. to indicate that the dipole 10 is operating according to a balanced or differential mode in a well-known manner. Balanced dual port dipole antennas like this have been studied extensively and can be made broadband and also scannable to a fair extent.

FIG. 1B illustrates a cross-section of a schematic radiation pattern from the dipole 10 cut along the axis DPI, and FIG. 1C illustrates a top view of said schematic radiation pattern, whereas FIG. 1D illustrates a schematic perspective view of the radiation pattern in FIGS. 1B-1C. As can be seen there is substantially no radiation emanating along the axis DPI, i.e. there is substantially no radiation from the short ends of the radiating elements 11a, 11b. This implies that an array antenna comprising a spatially extended collection of dipoles 10 will have a reduced ability to transmit electromagnetic radiation along the axis DP1 of the dipoles 10, as will be further described below. Naturally, the radiation pattern as now described is equally valid for reception.

The individual antenna elements in an array antenna may also be the well-known monopole 20 or similar, as schematically illustrated in FIGS. 2A-2D. The exemplifying monopole 20 in FIG. 2A has a single radiating element 21 extending ¼ (λ/4) of the utilized wavelength from a substantially horizontal ground plane 23 and along a substantially vertical axis MP. In other words, the monopole 20 is a quarter-wave antenna or a so-called Marconi antenna. The radiating element 21 is connected to a feeding line (not shown in FIG. 2a-2d) in a well-known manner for communicating high frequency signals to and from the monopole 20, and the radiating element 21 is fed by a single unbalanced current I₊ (not shown in FIG. 2a-2d) as is well-known in the art. Unbalanced single port monopole antennas like this have also been studied extensively.

FIG. 2B illustrates a cross-section of a schematic radiation pattern from the monopole 20 cut along the axis MP, and FIG. 2C illustrates a top-view of said schematic radiation pattern, whereas FIG. 2D illustrates a schematic perspective view of the radiation pattern in FIGS. 2B-2C. As can be seen there is substantially no radiation emanating along the axis MP, i.e. there is substantially no radiation emanating from the radiating element 21 along the normal to the ground plane 23. This implies that array antennas comprising a spatially extended collection of monopoles 20 will have a reduced ability to transmit electromagnetic radiation along the axis MP of the monopole, as will be further described below. Naturally, the radiation pattern as now described is also valid for reception. The attention is now directed to a first exemplifying array antenna arrangement, illustrated in FIGS. 3A and 3B.

FIG. 3A is a schematic top view of an exemplifying array antenna 30 comprising an array of three dipoles 30a, 30b, 30c, e.g. such as the dipole 10 illustrated in FIGS. 1A-1D. The dipoles 30a-30c in FIG. 3A are collinearly arranged along an axis DP2 on the surface of a substantially flat substrate 33. As is well-known, the first dipole 30a has two radiating elements 31aa, 31ab, each connected to a feeding line 32aa, 32ab, whereas the second dipole 30b has two radiating elements 31ba, 31bb, each connected to a feeding line 32ba, 32bb and the third dipole 30c has two radiating elements 31ca, 31cb, each connected to a feeding line 32ca, 32cb.

FIG. 3B is a schematic side view of the exemplifying array antenna 30 in FIG. 3A. As can be seen, the collinear radiating elements 31aa-31cb and the feeding lines 32aa-32cb are arranged on the surface of the substrate 33 so as to extend in the same or an adjacent plane. As is well-known, the direction of maximum radiation (the main lobe) of an antenna as the array antenna 30 in FIG. 3A-3B is perpendicular to the horizontal plane in which the radiating elements 31aa-31cb extend. This has been indicated in FIG. 3B by a first arrow 35 extending perpendicularly upwards from the substrate 33, and a second arrow 35′ extending perpendicularly downwards from the surface of the substrate 33. The second arrow 35′ has been drawn by dashed lines to indicate that the radiation in this direction may be attenuated, stopped or reflected by the substrate 33, i.a. depending on the composition of the material in the substrate 33.

The type of array antenna schematically illustrated in FIGS. 3A-3B is generally referred to as “broad side array” antennas, since the radiation originates predominately from the broadside of the array than from the end side. Scanning the main lobe 35 of the broadside antenna 30 is achieved in a well-known manner by prescribing a certain phase increment ψ between the antenna elements 30a, 30b, 30c in the scan direction Φ. Consequently, a first signal I₊, I₋ with a first phase angle θ is feed to the first antenna element 30a; a second signal I₊, I₋ with a second phase angle θ+ψ is fed to the second antenna element 30b and a third signal I₊, I₋ with a third phase angle θ+2ψ is feed to the third antenna element 30c. The scanning itself is accomplished by varying the phase increment ψ, as is well-known in the art of phase controlled array antennas. The signals I₊, I₋ mentioned above have been provided with opposite suffixes to indicate that they are out of phase by 180°, i.e. to indicate that the dipoles 30a-30c operate according to a balanced or differential mode in a well-known manner.

However, as the phase increment ψ increases so that the scan direction Φ of the main lobe 35 approaches 0°, i.e. approaches the horizontal direction in which the radiating elements 31aa-31cb extend, the impedance of the dipoles 30a-30c in the array antenna 30 changes in such a way that the matching deteriorates. This implies that an array antenna 30 comprising a spatially extended collection of dipoles 30a-30c or similar has a reduced ability to transmit electromagnetic radiation in directions that approaches the direction in which the radiating elements 31aa-31cb extend. In other words, there is substantially no radiation along the axis DP2, i.e. from the short ends of the radiating elements 31aa-31cb, which is consistent with the findings in connection with the single dipole 10 described above. Naturally, the radiation pattern as now described is also valid for reception.

The attention is now directed to a second exemplifying array antenna arrangement, illustrated in FIGS. 4A and 4B.

FIG. 4A is a schematic top view of an exemplifying array antenna 40 comprising an array of six monopoles 40a, 40b, 40c, 40d, 40e, 40f, e.g. such as the monopole 20 illustrated in FIGS. 2A-2D. Each monopole 40a-40f has a radiating element 41a-41f. The radiating elements 41a-41f are arranged in a straight line Li on the surface of a flat ground plane 43. Each radiating element 41a-41f is furthermore connected to a feeding line 41a-41f in a well-known manner.

FIG. 4B is a schematic side view of the exemplifying array antenna 40 in FIG. 4A. The radiating elements 41a-41f extend from the surface of the ground plane 43 along vertical axes MPa-MPf, whereas the feeding lines 42a-42f are arranged in or adjacent to the ground plane 43. As is well-known, the possible directions of maximum radiation (the main lobes) of an antenna as the array antenna 40 extend along the line L1—i.e. along the line of radiating elements 41a-41f—and in parallel to the ground plane 43. This is indicated in FIG. 4B by a first arrow 45 to the right and a second arrow 45′ to the left.

The type of array antenna 40 schematically illustrated in FIGS. 4A-4B is generally referred to as an “end-fire array” antenna, since the radiation originates predominately from the end of the array and not predominately from the broadside of the array as in the broad-side array antenna 30 in FIGS. 3A-3B. Some scanning of the main lobe 45, 45′ of the end-fire array antenna 40 may be achieved in a well-known manner by prescribing a certain phase increment ψ between the antenna elements 40a-40f in the scan direction Φ. Consequently, a first signal I₊ with a first phase angle θ can be feed to the first antenna element 40a; a second signal I₊ with a second phase angle θ+ψ can be fed to the second antenna element 40b; a third signal I+with a third phase angle θ+2ψ can be feed to the third antenna element 40c, and so on to a sixth signal I₊ with a sixth phase angle θ+5ψ that is feed to the sixth antenna element 40f. The scanning is then accomplished by varying the phase increment ψ, as is well-known in the art of phase controlled array antennas. The signal I₊ have been provided with positive suffix to indicate that the signals fed to the monopole has the same original phase θ, i.e. to indicate that the monopoles 40a-40f operate according to an unbalanced or sum-mode in a well-known manner.

However, as the phase increment ψ increases so that the scan direction Φ of the main lobe 45 or 45′ approaches 90°, i.e. approaches the vertical direction in which the radiating elements 41a-41f extend, the impedance of the antenna elements 40a-40f in the array antenna 40 changes in such a way that the matching deteriorates. This implies that an array antenna 40 comprising a spatially extended collection of monopoles 40a-40f or similar has a reduced ability to transmit electromagnetic radiation in directions that approaches the vertical direction in which the radiating elements 41a-41f extend. In other words, there is substantially no radiation along the axes MPa-MPf of the radiating elements 41a-41f, i.e. along the normal to the ground plane, which is consistent with the findings in connection with the single monopole 20 described above. Naturally, the radiation pattern as now described is also valid for reception.

To summarize, the well-known dipole 10 and the well-known monopole 20 and variations thereof are frequently used as single antenna elements in array antennas, e.g. as in the broadside antenna 30 in FIGS. 3A-3B and in the end-fire antenna 40 in FIGS. 4A-4B. However, almost without exception the antenna lobe of these single antenna elements have formally at least one null point, i.e. at least one direction in which the antenna element cannot not readily transmit and receive electromagnetic radiation. It follows that an array antenna comprising a spatially extended collection of several such antenna elements is typically showing at least one direction in which the antenna lobe of the array antenna cannot be readily directed, i.e. there is at least one null point in the antenna diagram of an array antenna comprising such antenna elements.

Consequently there is a need for an improved array antenna and particularly an array antenna with improved ability to direct the antenna lobe, especially so as to reduce possible null points.

### SUMMARY OF THE INVENTION

The invention provides an improved array antenna, an array antenna system and an improved method of utilizing the improved array antenna and array antenna system.

This is accomplished by an array antenna comprising a region of reference potential, e.g. a ground plane, and a spatially extended collection of at least two antenna elements capable of being at least partly balanced driven and at least partly unbalanced driven. The antenna elements have a first radiating element connected to a first port and a second radiating element connected to a second port. In other words, the antenna element has at least two ports. The radiating elements are arranged substantially adjacent and parallel to each other so as to extend at least a first distance approximately perpendicularly from said region of reference potential. The antenna element is further comprising a radiating arrangement connected to said first and said second radiating elements so as to extend at least a second distance above and approximately parallel to said region of ground reference.

An embodiment of the invention comprises an array antenna wherein said radiating arrangement comprises a substantially continuous radiating element connected to said first radiating element and to said second radiating element. The continuous radiating element may e.g. be a loop element.

Another embodiment of the invention comprises an array antenna wherein said radiating arrangement comprises a third radiating element connected to said first radiating element and a fourth radiating element connected to said second radiating element.

A further embodiment of the invention comprises an array antenna wherein said third and fourth radiating element is chosen from a group of elements comprising: substantially straight thread shaped or cylindrically shaped elements; curved substantially loop shaped elements; substantially flat plate elements. The expression “flat plate elements” is intended to also comprise plate elements that are slightly curved.

The invention is also accomplished by an antenna system comprising an array antenna according to the above wherein the first and second ports of the antenna elements are connected to a feeding arrangement. The feeding arrangement is arranged so as to varying the phase difference φ₁ between: a first signal I₁ communicated between the first port and the feeding arrangement; and a second signal I₂ communicated between the second port and the feeding arrangement.

An embodiment of the invention comprises a feeding arrangement comprising a device, e.g. a balun. The device is arranged so that a signal I₀ (e.g. I₀e^{i(ψn)}) communicated with a first terminal SUM of the device is divided with a first substantially fixed phase difference φ₁ (e.g. substantially 0°) between a first signal I₁ and a second signal I₂ communicated between the feeding arrangement and the antenna element. The device is further arranged so that a signal I₀ (e.g. I₀e^{i(ψn)}) communicated with a second terminal DIFF of said device is divided with a second substantially fixed phase difference φ₂ (e.g. substantially 180°) between a first signal I₁ and a second signal I₂ communicated between the feeding arrangement and the antenna element.

Said device may in an further embodiment have the first device terminal SUM and the second device terminal DIFF connected to a switch, which in a first position enables a signal I₀ to be communicated with the first device terminal SUM, and in a second position enables a signal I₀ to be communicated with the second device terminal DIFF.

Another embodiment of the invention comprises a feeding arrangement comprising a distribution arrangement (e.g. a combiner/divider) connected to said first and said second port and to a feeding line. The distribution arrangement is arranged so as to combine signals I₁, I₂ received from said ports into said feeding line, and to divide a signal 10 (e.g. I₀e^{i(ψn)}) received from said feeding line between said ports. The feeding arrangement is also comprising at least one phase shifter connected between at least one of said ports and said distribution arrangement so as to varying the phase φ of a signal communicated between that port and the distribution arrangement.

The invention is further accomplished by a method for transmitting or receiving by means of an array antenna comprising: a region of reference potential and a spatially extended collection of at least two antenna elements capable of being at least partly balanced driven and at least partly unbalanced driven. The antenna elements have a first radiating element connected to a first port and a second radiating element connected to a second port. In other words, the antenna element has at least two ports. The radiating elements are arranged substantially adjacent and parallel to each other so as to extend at least a first distance approximately perpendicularly from said region of reference potential. The antenna element is further comprising a radiating arrangement connected to said first and said second radiating elements so as to extend at least a second distance above and approximately parallel to said region of ground reference. The method includes the steps of transmitting or receiving electromagnetic radiation by the antenna elements in a variable direction by varying the phase difference φ between a first signal I₁ communicated with the first port of the antenna element and a second signal I₂ communicated with the second port.

A method according to an embodiment of the invention accomplishes the phase difference φ by using a feeding arrangement connected to the first and second port of each antenna element. The feeding arrangement is arranged to varying the phase difference φ between: a first signal I₁ communicated between said first port and said feeding arrangement; and a second signal I₂ communicated between said second port and said feeding arrangement.

An embodiment of the method uses a feeding arrangement comprising a device arranged so that a signal I₀ (e.g. I₀e^{i(ψn)}) communicated with a first terminal SUM of the device is divided with a first substantially fixed phase difference φ (e.g. substantially 0°) between said first signal i₁ and said second signal I₂. The feeding device is further arranged so that a signal I₀ (e.g. I₀e^{i(ψn)}) communicated with a second terminal DIFF of the device is divided with a second substantially fixed phase difference (φ (e.g. substantially 180°) between said first signal I₁ and said second signal I₂.

Said device may in an embodiment have the first device terminal SUM and the second device terminal DIFF connected to a switch, which is operated so that in a first position the signal 10 is communicated with the first device terminal SUM, and so that in a second position the signal I₀ is communicated with the second device terminal DIFF.

Another embodiment of the method uses a feeding arrangement comprising a distribution arrangement (e.g. a combiner/divider) is connected to said first and second ports and to a feeding line; and being arranged so as to combine signals I₁, I₂ received from said ports into said feeding line, and to divide a signal I₀ (e.g. I₀e^{i(ψn)}) received from said feeding line between said ports. The feeding arrangement is also comprising at least one phase shifter connected between at least one of said ports and said distribution arrangement so as to varying the phase q) of a signal communicated between that port and the distribution arrangement.

These and other aspects of the present invention will be apparent from the following description of embodiment(s) of the invention.

### BRIEF DESCRIPTION OF THE DRAWINGS

FIG. 1a is a schematic illustration of a side view of a well-known dipole 10.

FIG. 1b is a schematic illustration of a cross-section of a radiation pattern from the dipole in FIG. 1a.

FIG. 1c is a schematic illustration of a top view of the radiation pattern in FIG. 1b.

FIG. 1d is a schematic illustration of a perspective view of the radiation pattern in FIG. 1b-1c.

FIG. 2a is a schematic illustration of a side view of a well-known monopole 20.

FIG. 2b is a schematic illustration of a cross-section of the radiation pattern from the monopole 20 in FIG. 2a.

FIG. 2c is a schematic illustration of a top-view of the radiation pattern in FIG. 2b.

FIG. 2d is a schematic illustration of a perspective view of the radiation pattern in FIG. 2b-2c.

FIG. 3a is a schematic illustration of a top view of an exemplifying broadside array antenna 30.

FIG. 3b is a schematic illustration of a side view of the array antenna 30 in FIG. 3a.

FIG. 4a is a schematic illustration of a top view of an exemplifying end-fire array antenna 40.

FIG. 4b is a schematic illustration of a side view of the array antenna 40 in FIG. 4a.

FIG. 5a is a schematic illustration of a top view of an array antenna 50 according to a preferred embodiment of the present invention.

FIG. 5b is a schematic illustration of a side view of the array antenna 50 in FIG. 5a.

FIG. 6a is a schematic illustration of the array antenna 50 in FIG. 5a-5b provided with a feeding arrangement according to a first embodiment.

FIG. 6b is a schematic illustration of the array antenna 50 in FIG. 5a provided with a feeding arrangement according to a second embodiment.

FIG. 7a is a schematic illustration of a loop antenna element.

FIG. 7b is a schematic illustration of a dipole having a parasitic or resonator element.

FIG. 7c is a schematic illustration of a dipole having tilted dipole arms.

FIG. 7d is a schematic illustration of a double probe fed bunny-ear antenna element.

FIG. 7e is a schematic illustration of a double probe fed patch antenna element having a parasitic or resonator element.

FIG. 7f is schematic illustration of a double polarized embodiment of a dipole antenna element.

FIG. 7g is schematic illustration of a double polarized embodiment of a dipole antenna element known as the four-square antenna element.

FIG. 7h is a schematic illustration of a patch element array antenna with a corner feeding arrangement.

### DETAILED DESCRIPTION OF PREFERRED EMBODIMENTS OF THE INVENTION

The present invention will now be described in more detail with reference to exemplifying embodiments thereof. Other embodiments of the invention are clearly conceivable and the invention is by no means limited to the exemplifying array antennas and feeding arrangements described below. It should also be added that the same or similar reference numbers used in the present text indicate the same or similar objects and/or functions throughout the whole text.

### The Array Antenna

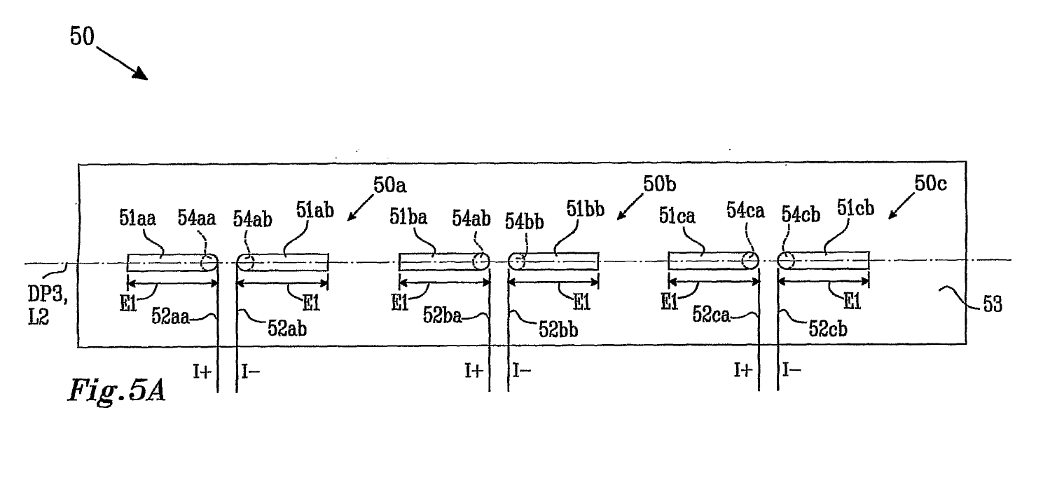

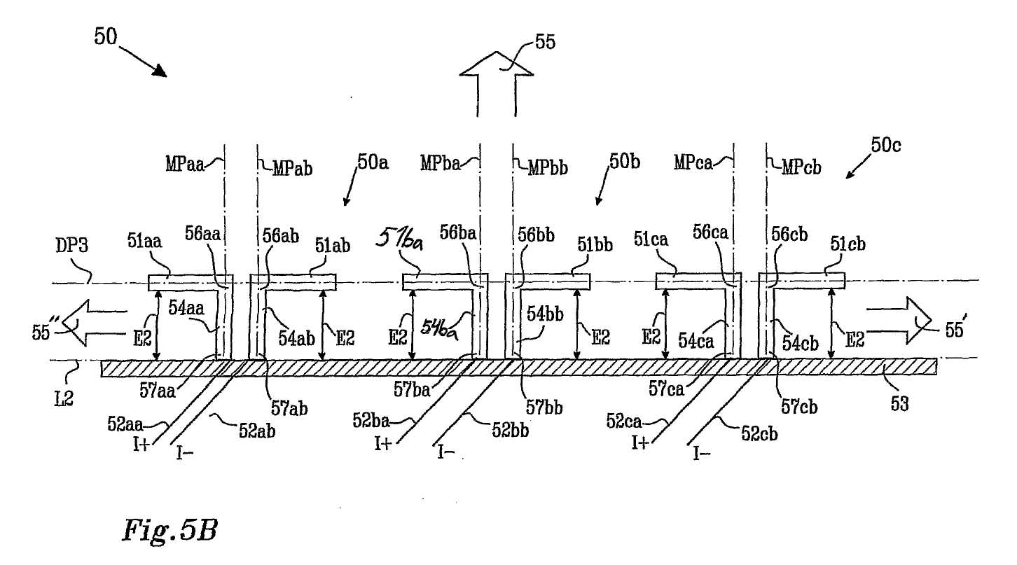

FIGS. 5A and 5B is a schematic illustration of an array antenna 50 according to a preferred embodiment of the present invention.

FIG. 5A is a schematic top view of the array antenna 50 comprising an array of three dipoles 50a, 50b, 50c substantially collinearly arranged along an axis DP3.

In particular:
the first dipole 50a has two opposite and separated radiating elements 51aa, 51ab, each directly or at least indirectly connected to a feeding line 52aa, 52ab;
the second dipole 50b has two opposite and separated radiating elements 51ba, 51bb, each directly or at least indirectly connected to a feeding line 52bab, 52bb;
the third dipole 50c has two opposite and separated radiating elements 51ca, 51cb, each directly or at least indirectly connected to a feeding line 52ca, 52cb.

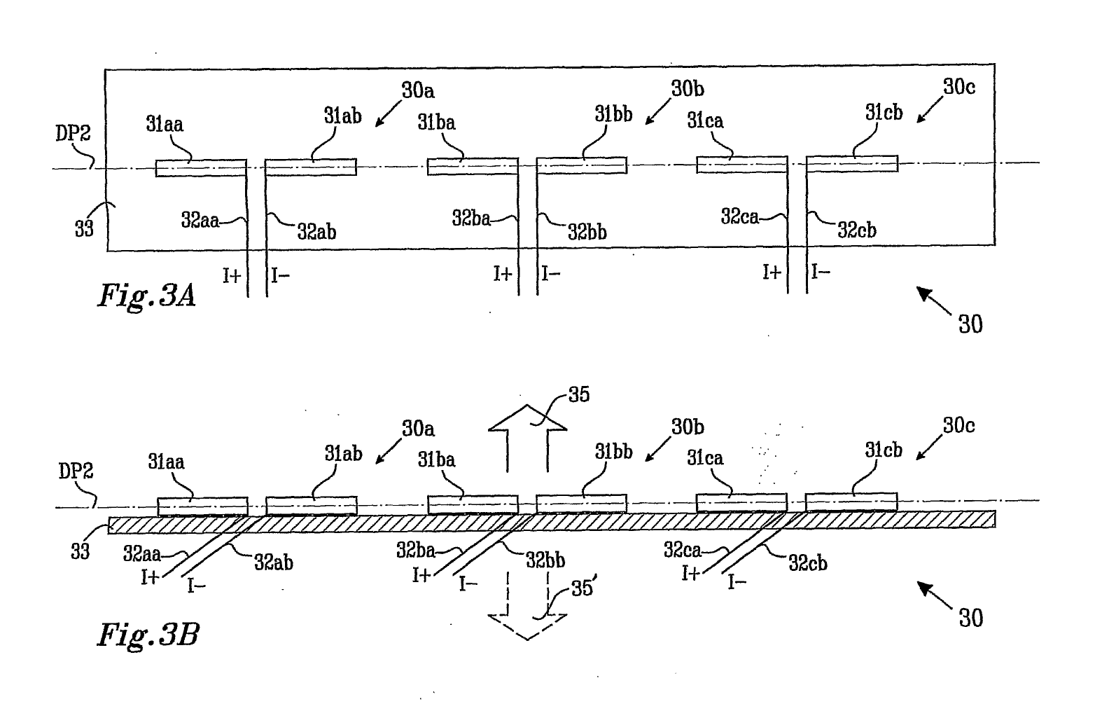

The radiating elements 51aa-51cb of the dipoles 50a-50c are preferably shaped as elongated threads, cylinders or rectangles extending a distance E1 of roughly ¼ (λ/4) of the utilized wavelength along the axis DP3. In other words, the dipoles 50a-50c are arranged in a similar way as the dipoles 30a-30c in the array antenna 30 described above with reference to FIGS. 3A-3B. However, other lengths and forms of the radiating elements 51aa-51cb are clearly conceivable, given that the function of radiating elements in a broadside array antenna can be substantially preserved. The length may e.g. assume other multiples of the utilized wavelength or even slightly depart from multiples of the utilized wavelength, whereas the form of a radiating element may e.g. be curved and/or extend at various angles etc.

FIG. 5B is a side view of the array antenna 50 in FIG. 5A, illustrating that each radiating element 51aa-51cb is substantially horizontally arranged on a vertical element 54aa-54cb, so as to extend a certain distance above a ground plane 53. A horizontal radiating element 51aa-51cb and a vertical element 54aa-54cb form an L-shaped structure (the L turned upside down and possibly rotated), whereas two adjacent vertical elements 54aa-54cb each provided with a horizontal radiating element 51aa-51cb form a T-shaped structure.

It is preferred that the above mentioned ground plane 53 is substantially flat and that the horizontal elements 51aa-51cb extend substantially in parallel to the ground plane 53, i.e. it is preferred that the ground plane 53 is substantially parallel to the axis DP3 along which the horizontal elements 51aa-51cb extend. However, other embodiments of the invention may have a ground plane 53 or a region of ground potential that is curved or assumes other shapes that wholly or partly depart from a flat shape. In some embodiments the ground plane 53 or region of ground potential may e.g. be formed by a grid of conductors or similar or even by a grid of point shaped ground regions.

Regarding the vertical elements 54aa-54cb illustrated in FIG. 5B it is preferred that they are electrically arranged so that the:
upper distributing end 56aa of the vertical element 54aa is connected to the right end of the horizontal element 51aa;
upper distributing end 56ab of the vertical element 54ab is connected to the left end of the horizontal element 51ab;
upper distributing end 56ba of the vertical element 54ba is connected to the right end of the horizontal element 51ba;
upper distributing end 56bb of the vertical element 54bb is connected to the left end of the horizontal element 51bb;
upper distributing end 56ca of the vertical element 54ca is connected to the right end of the horizontal element 51ca;
upper distributing end 56cb of the vertical element 54cb is connected to the left end of the horizontal element 51cb;
lower feeding end 57aa of the vertical element 54aa is connected to the feeding line 52aa;
lower feeding end 57ab of element 54ab is connected to the feeding line 52ab;
lower feeding end 57ba of element 54ba is connected to the feeding line 52ba;
lower feeding end 57bb of element 54bb is connected to the feeding line 52bb;
lower feeding end 57ca of element 54ca is connected to the feeding line 52ca;
lower feeding end 57cb of element 54cb is connected to the feeding line 52cb.

The feeding lines 52aa, 52ab connected to the feeding ends 57aa, 57ab respectively forms two ports, and feeding lines 52ba, 52bb connected to the feeding ends 57ba, 57bb respectively form another two ports, whereas the feeding lines 52ca, 52cb connected to the feeding ends 57ca, 57cb respectively forms still another two ports.

In addition, the vertical elements 54aa-54cb in FIG. 5B are preferably extending a distance E2 of roughly ¼ (λ/4) of the utilized wavelength from the horizontal ground plane 53 along vertical and substantially parallel axes MPaa-MPcb, i.e. the vertical elements 54aa-54cb are substantially perpendicular to the axis DP3 and the ground plane 53 in FIG. 5B. However, other lengths and forms of the vertical elements 54aa-54cb are clearly conceivable, given that the function of a radiating element in an end-fire array antenna can be substantially preserved, as will be explained further below. The length may e.g. assume other multiples of the utilized wavelength or even slightly depart from multiples of the utilized wavelength, whereas the form of a radiating element may be curved and/or extend at various angles etc.

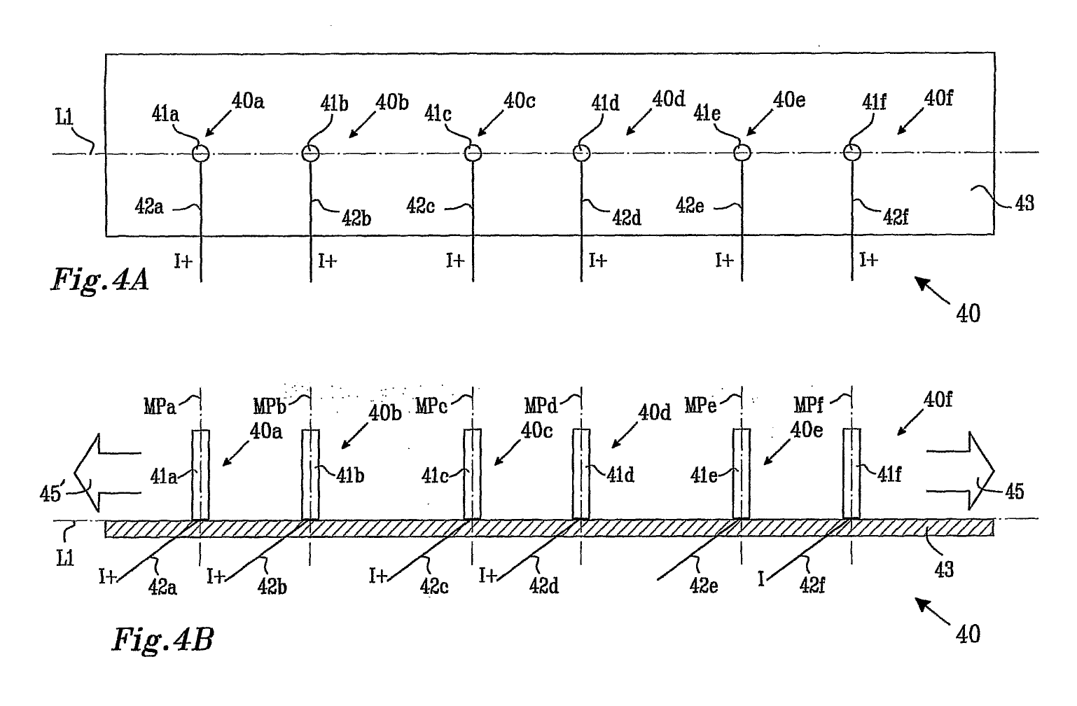

As can be seen in FIGS. 5A-5B, the vertical elements 54aa-54cb are arranged in pairs 54aa, 54ab; 54ba, 54bb; 54ca, 54cb on the surface of the ground plane 53 and along a substantially straight line L2, which line L2 is preferably parallel or substantially parallel to the axis DP3. In other words, the vertical elements 54aa-54cb in FIGS. 5A-5B are arranged in a similar way as the monopoles 40a-40f in FIGS. 4A-4B, except that the monopoles 40a-40f in FIGS. 4A-4B are evenly spaced individuals whereas the vertical elements 54aa-54cb in FIGS. 5A-5B are adjacently arranged in substantially evenly spaced pairs.

It is preferred that the schematically illustrated feeding lines 52aa-52cb in FIGS. 5A-5B are arranged so as to extend in a plane adjacent to the preferred ground plane 53, i.e. above or beneath the ground plane 53. This arrangement of the feeding lines 52aa-52cb implies that the horizontal elements 51aa-51cb in FIGS. 5A-5B are not directly connected to the feeding lines 52aa-52cb but connected via the vertical elements 54aa-54cb. Hence, the horizontal elements 51aa-51cb may be consider as indirectly connected to the feeding lines 52aa-52cb. On the other hand, one may also consider the vertical elements 54aa-54cb as extensions of the feeding lines 52aa-52cb, i.e. as a being a part of the feeding lines 52aa-52cb.

From the above it can be concluded that the substantially horizontal radiating elements 51aa-51cb of the array antenna 50 in FIGS. 5A-5B are similar to the horizontal radiating elements 31aa-31cb of the broadside array antenna 30 in FIGS. 3A-3B. It follows that the radiating elements 51aa-51cb can be utilized in the same way or at least in a similar way as the radiating elements 31aa-31cb of the broadside array antenna 30.

It can also be concluded from the above that the substantially vertical elements 54aa-54cb of the array antenna 50 in FIG. 5A-5B resembles the vertical radiating elements 41a-41f of the end-fire array antenna 40 in FIGS. 4A-4B. This resemblance is not accidental. In fact, the vertical elements 54aa-54cb of the array antenna 50 can be utilized in same way or at least in a similar way as the vertical elements 41aa-41cb of the end-fire array antenna 40, as will be further described below.

However, before we proceed it should be emphasised that the invention is not in any way limited to a single row of three collinear dipoles 50a-50c as shown in FIGS. 5A-5B. On the contrary, an array antenna according to the present invention may comprise anything from two antenna elements to a plurality of antenna elements arranged in one or several rows. In addition, the antenna elements must not necessarily be dipoles and the antenna elements must not necessarily be arranged in a line or in a row. On the contrary, the antenna elements or at least a subset of the antenna elements may be arranged at different heights and according to other patterns than rows, e.g. slightly departing from a row so as to form a zigzag-pattern or similar, or arranged in groups of several antenna elements where the groups (but not necessarily the individual antenna elements in a group) are arranged substantially in a row or similar. It should also be emphasised that the description of the horizontal radiating elements 51aa-51cb and the vertical elements 54aa-54cb should not be understood as limited to transmission of electromagnetic radiation. On the contrary, the description is equally valid for reception of electromagnetic radiation.

### Scanning the Main Lobe

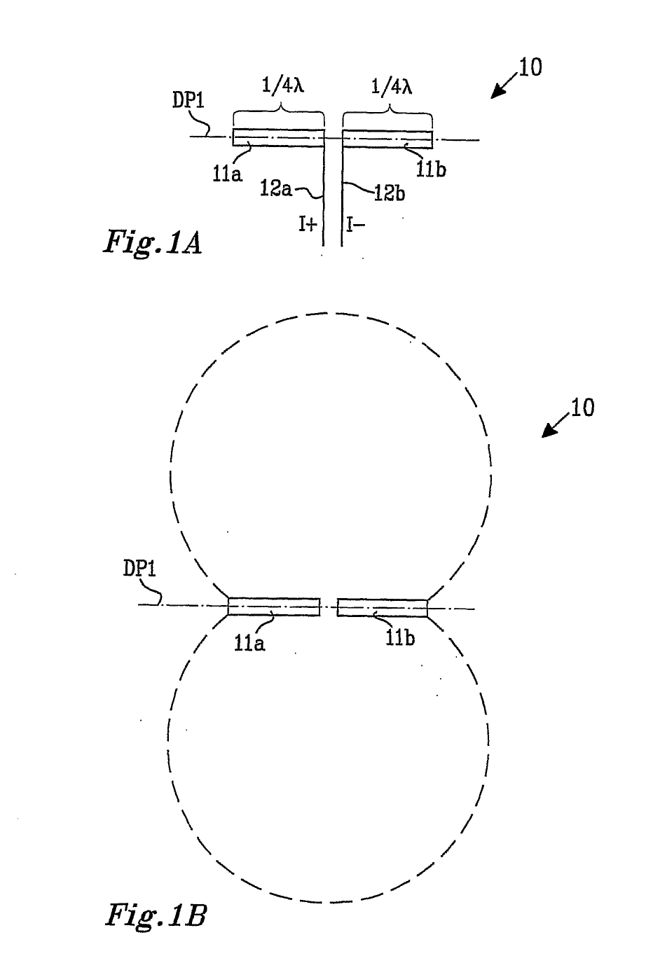

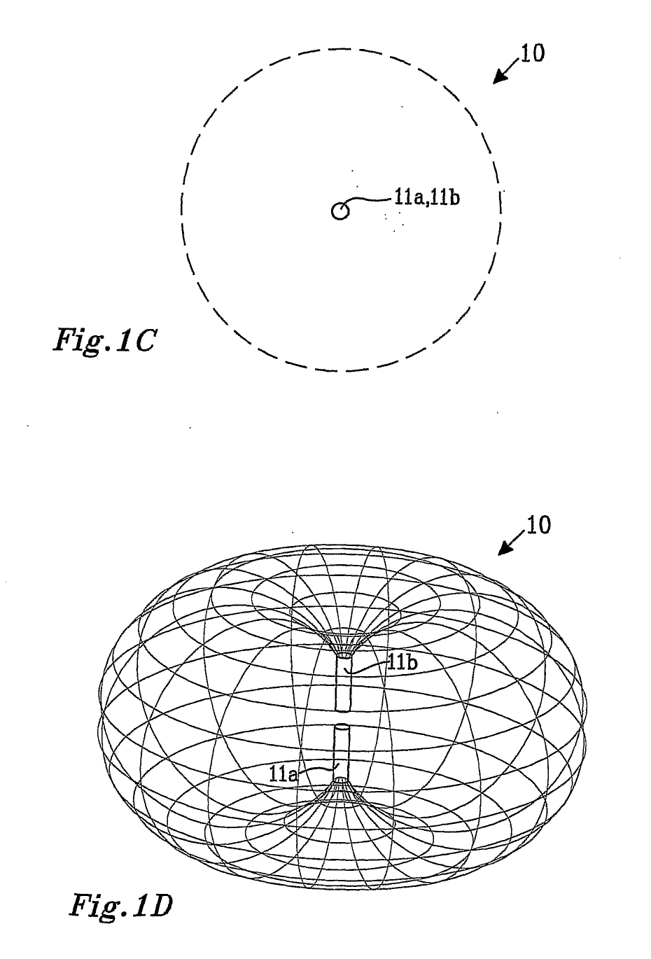

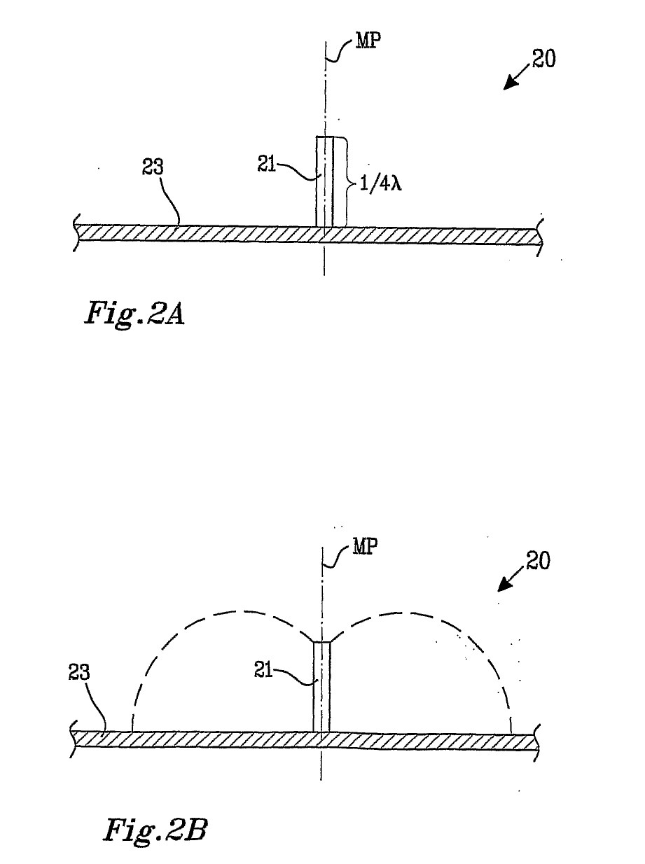

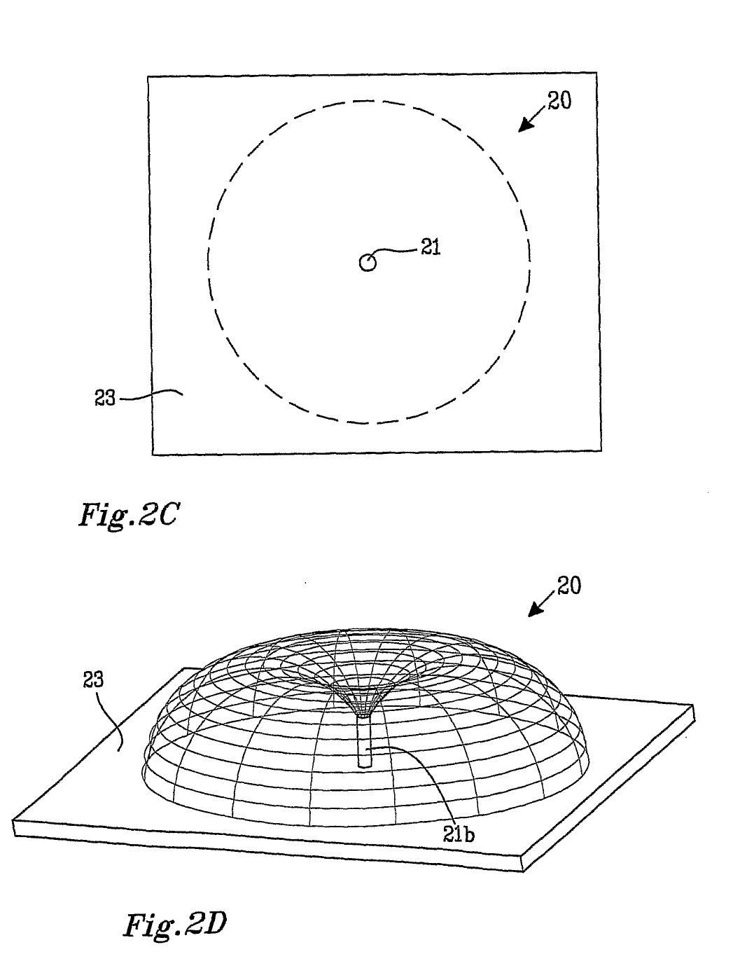

As previously explained in connection with the single dipole 10 in FIGS. 1A-1B one usually considers the balanced or differential mode current I_{diff}=(I₁−I₂)/2 to be the current that excites the dipole and the power conveyed by I_{diff} is supposed to be converted to radiated electromagnetic power.

In accordance therewith, the differential mode for the three dipole antenna elements 30a, 30b, 30c of the array antenna 30—as described above with reference to FIGS. 3A-3B—has been illustrated by a first current I₊ fed to a first feeding line 32aa, 32ba, 32ca of the dipoles 30a, 30b, 30c, and a second current I₋ fed to a second feeding line 32ba, 32bb, 32cb of the dipoles 30a, 30b, 30c. The currents I₊, I₋ have opposite suffixes to indicate that they are out of phase by 180°, i.e. that the dipoles 30a, 30b, 30c operate according to a differential mode in a well known manner.

As previously established, the three dipoles 30a, 30b 30c of the array antenna 30 in FIGS. 3A-3B are similar to the three dipoles 50a, 50b 50c of the array antenna 50 in FIGS. 5A-5B. The dipoles 50a-50c of the array antenna 50 can therefore be excited in a differential or balanced mode in the same way or at least in a similar way as the dipoles 30a-30c, or for that matter in the same way or at least in a similar way as the dipole 10 in FIGS. 1A-1D.

Hence the dipoles 50a-50c can be excited by supplying the dipoles 50a, 50b, 50c with:
a current I₊ to the first feeding line 52aa and a current I₋ to the second feeding line 52ab;
a current I₊ to the first feeding line 52ba and a current I₋ to the second feeding line 52bb;
a current I₊ to the first feeding line 52ca and a current I₋ to the second feeding line 52cb.

The direction of maximum radiation (the main lobe) of the dipoles 50a-50c in a differential or balanced mode is substantially perpendicular to the axis DP3 along which the radiating elements 51aa-51cb extend. Hence, the main lobe is therefore also substantially perpendicular to the ground plane 53, as explained above. The main lobe has been indicated in FIG. 5B by an arrow 55 extending vertically and substantially perpendicularly upwards from the ground plane 53. As can be seen, the main lobe 55 that originates from the dipoles 50a-50c of the array antenna 50 in FIGS. 5A-5B is essentially the same as the main lobe 35 originating from the dipoles 30a-30c in the broadside array antenna 30 in FIGS. 3A-3B.

As previously explained in connection with the array antenna 30, the main lobe 55 of the antenna 50 can be scanned by prescribing a phase increment ψ between the antenna elements 50a-50c of the antenna 50. However, if the phase increment ψ increases so that the direction Φ of the main lobe approaches the direction in which the horizontal radiating elements 51aa-51cb extend in FIGS. 5A-5B, the impedance of the antenna elements 50a-50c changes in such a way that the matching deteriorates. The radiating elements 51aa-51cb of the dipoles 50a-50c in the array antenna 50 will therefore show a reduced ability to transmit electromagnetic radiation in the horizontal direction, i.e. along the line DP3 or in other words substantially perpendicular to the normal of the ground plane 53 in FIGS. 5A-5B. Consequently, there can be substantially no radiation from the dipoles 50a-50c of the array antenna 50 along the axis DP3 extending along the radiating elements 51aa-51cb and substantially in parallel to the horizontal ground plane 53 in FIG. 5B.

As a contrast, the end-fire array antenna 40 described above with reference to FIGS. 4A-4B has its main lobe(s) 45, 45′ extending along the line L1 and along the horizontal ground plane 43 in FIGS. 4A-4B. However, the end-fire array antenna 40 has a reduced ability to transmit electromagnetic radiation in directions that approaches the vertical direction in which the radiating elements 41a-41f extend in FIG. 4B, i.e. in a direction substantially perpendicular to the ground plane 43.

Hence, it would be advantageous if the ability of the broadside array antenna 30 to transmit electromagnetic radiation in a vertical plane, as described above with reference to FIGS. 3A-3B, could be combined with the ability of the end-fire antenna 40 to transmit electromagnetic radiation in a horizontal plane, as described above with reference to FIGS. 4A-4B. This would give a considerable improvement of the possibility of directing the antenna lobe of the array antenna; especially in directions that are otherwise inaccessible, i.e. in the direction of so-called null points.

To this end, a similar function as the one of the monopoles in the end-fire array antenna 40 described above can be accomplished in the array antenna 50. In particular, this can be accomplished by utilizing the grouped pairs of elements 54aa, 54ab; 54ba, 54bb; 54ca, 54cb arranged substantially along the line L2 and extending in a substantially vertical direction from the ground plane 53.

Hence, the vertical elements 54aa-54cb of the dipoles 50a-50c in FIGS. 5A-5B are excited in a sum-mode (not shown in FIG. 5a-5b) by supplying the dipoles 50a, 50b, 50c with:
a current I₊ to the first feeding line 52aa and a current I₊ to the second feeding line 52ab;
a current I₊ to the first feeding line 52ba and a current 1₊ to the second feeding line 52bb;
a current I₊ to the first feeding line 52ca and a current I₊ to the second feeding line 52cb.

In the sum-mode the radiation from the opposite pairs of horizontal elements 51aa, 51ab; 51ba, 51bb; 51ca, 51cb will substantially cancel each other, whereas each pair of adjacently arranged vertical elements 54aa, 54ab; 54ba, 54bb; 54ca, 54cb will essentially function as a single quarter-wave monopole, i.e. elements 51aa, 51ab will function as a first monopole, the elements 51ba, 51bb will function as a second monopole and the elements 51ca, 51cb will function as a third monopole in the sum-mode. Naturally, this presupposes that the vertical elements 54aa, 54ab; 54ba, 54bb; 54ca, 54cb in a pair are arranged close enough to be able to cooperate as a single monopole or similar and to allow the horizontal elements 51aa, 51ab; 51ba, 51bb; 51ca, 51cb in the pair to cooperate as a dipole or similar.

In addition, the radiation from the vertical elements of a pair 54aa, 54ab; 54ba, 54bb; 54ca, 54cb do essentially cancel each other when the dipoles 50a-50c are excited in a differential mode, since the currents in the elements of a pair have opposite directions in the differential mode.

From the above it follows that an excitation of the vertical elements 52aa-52cb of the antenna elements 50a-50c in a sum-mode enables the main antenna lobe 55 of the array antenna 50 to be pointed in a direction Φ that approaches or even coincides with the horizontal direction in which the radiating elements 51aa-51cb of the dipoles 50a-50c extend, i.e. substantially as the end-fire antenna 40 described above with reference to FIGS. 3A-3B. This is illustrated in FIG. 5B by two opposite arrows 55′ and 55″ representing the possible end-fire directions for the antenna lobe 55 of the array antenna 50.

In other words, the substantially horizontal elements 51aa-51cb of the array antenna 50 can be fed in a differential mode and utilized for radiating electromagnetic radiation in a similar way as a broadside dipole array antenna (e.g. as the broadside array antenna 30 in FIGS. 3A-3B), whereas the substantially vertical elements 54aa-54cb of the array antenna 50 can be fed in a sum-mode and utilized for radiating electromagnetic radiation in a similar way as an end-fire antenna (e.g. as the end-fire array antenna 40 in FIGS. 4A-4B).

The point of optimum switch-over between the differential mode and the sum-mode depend i.a. on the E-plane pattern cut for a single polarised antenna element.

The switch-over can be substantially continuous, e.g. a continuous decreasing of the 180° phase difference between the two currents I₊, I₋ fed to the dipoles 50a-50c in a differential mode so as to approach and/or target the 0° phase difference between the currents I₊, I₊ fed to the dipoles 50a-50c in a sum-mode and back again.

The switch-over can also be a more or less two-way switching, e.g. a switch-over that simply toggles or switches between the 180° phase difference between the currents I₊, I₋ fed to the dipoles 50a-50c in a differential mode and the 0° phase difference between currents I₊, I₊ fed to the dipoles 50a-50c in a sum-mode.

In particular, a substantially continuous or step-less switch-over between a differential fed (I₊, I₋) and a sum fed (I₊, I₊) enables the array antenna 50 to transmit electromagnetic radiation in substantially any direction Φ along a half circle extending substantially perpendicularly from the ground plane 53 in the plane that is defined by the axis DP3 and the line L2, i.e. in the direction of the arrow 55 in FIGS. 5A-5B.

The point of optimum switch-over between the differential mode and the sum-mode, or the optimum mix of a differential mode and a sum-mode—i.e. the optimum phase difference between the two currents fed to a dipole 50a-50c—can e.g. be empirically determined by measuring the antenna pattern, as is well-known in the art. A measuring may e.g. be achieved by exciting the dipoles 50a-50c as described above, and prescribing a phase difference φ between the two feeding currents that is step-wise varied in a plurality of small steps from 0° to 180° (i.e. altering the excitation from a sum-mode 0° to a differential mode 180° by several small steps) and continuously measuring the electromagnetic radiation transmitted in different directions by the array antenna 50.

Naturally, the radiating (transmitting) ability as now described is equally valid for receiving, i.e. a suitably switching between a differential reception (I₊,I₋) and a sum reception (I₊, I₊) enables the array antenna 50 to receive electromagnetic radiation in substantially any direction Φ along a half circle extending substantially perpendicularly from the ground plane 53 in the plane that is defined by the axis DP3 and the line L2, i.e. in the direction of the arrow 55 in FIGS. 5A-5B. The point of optimum switch-over between the differential mode and the sum-mode or even the optimum mix of a differential mode and a sum-mode can therefore alternatively be measured by transmitting electromagnetic radiation towards the array antenna 50 from one direction after the other and continuously measure the phase and magnitude of the two currents received from each dipole 50a-50c in a well-known manner.

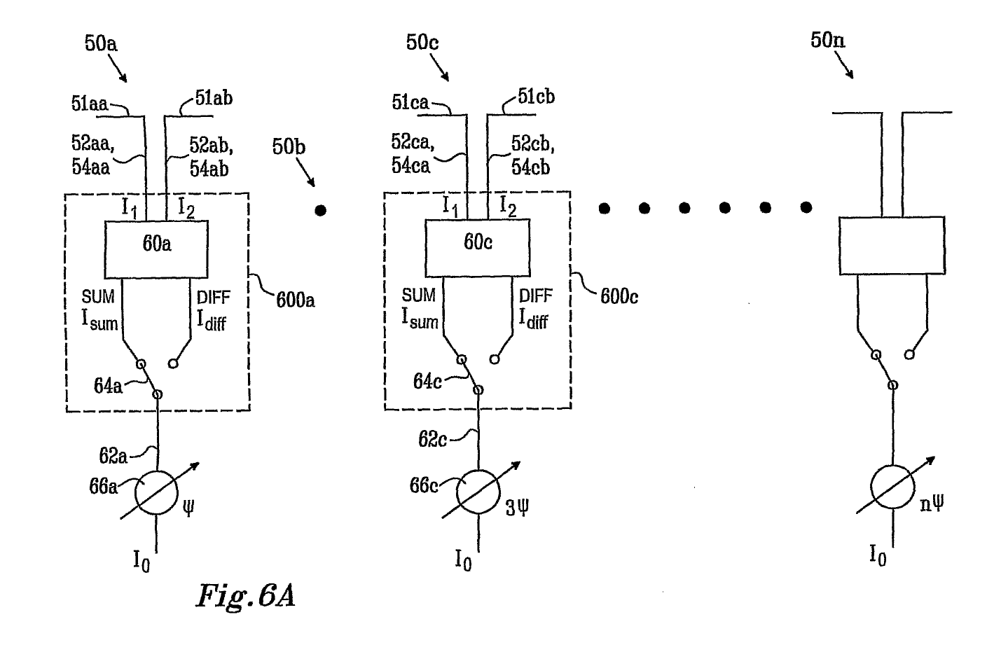

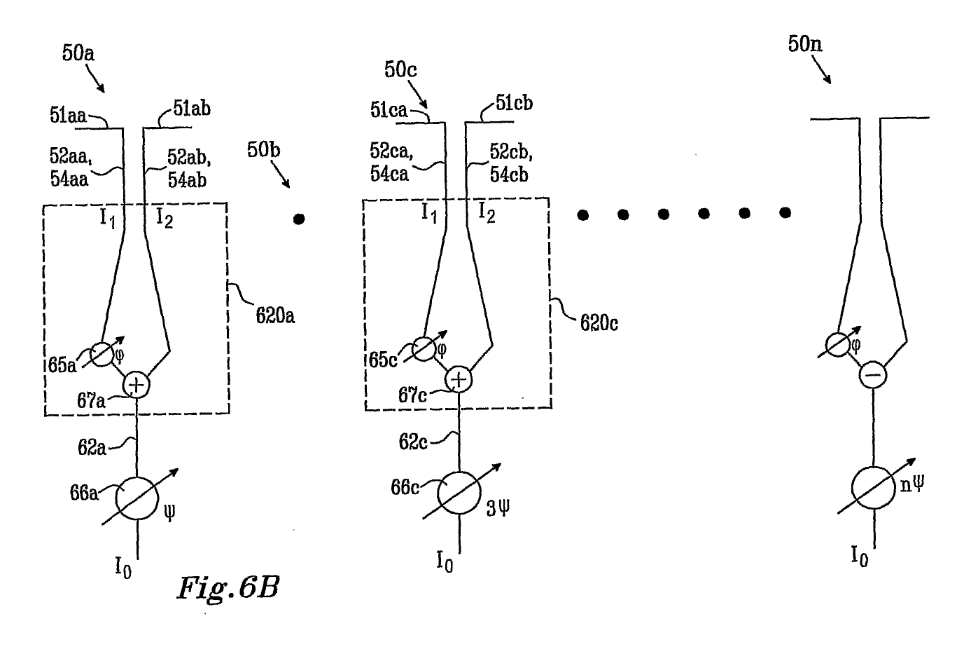

To achieve a suitable switch-over between a differential mode (I₊, I₋) and a sum-mode (I₊, I₊) it is preferred that the dipoles 50a-50c of the array antenna 50 is connected to a device that feeds the dipole antenna elements 50a-50c with an I_{diff}=(I₁−I₂)/2 and an Iₛᵤₘ=(I₁+I₂)/2 in a proportion that enhances or maximizes the power conversion to and from the dipole antenna elements 50a-50c of the array antenna 50. Preferred embodiment of such feeding devices will now be described with reference to FIGS. 6A-6C.

FIGS. 6A-6B comprises schematic illustrations of the array antenna 50 in FIGS. 5A-5B. As can be seen, only the first dipole 50a and the third dipole 50c are illustrated. The connection and feeding of a single dipole antenna element 50a will be now described with reference FIGS. 6A-6B. It should be emphasized that the same is valid mutatis mutandis for the other dipole elements 50b and 50c in the array antenna 50 and further dipole elements 50n that may be arranged in an array antenna according to various embodiments of the present invention.

The dipole 50a is the same as the one illustrated in FIGS. 5A-5B. Consequently, the dipole 50a in FIG. 6A-6C has horizontal elements 51aa, 51ab, vertical elements 54aa, 54ab and feeding lines 52aa, 52ab in the same way as previously described with reference to FIGS. 5A-5B.

As can be seen in FIG. 6A a feeding arrangement 600a comprising a feeding device 60a and a two-way switch 64a. The feeding device 60a is connected to the feeding lines 52aa, 52ab of the dipole antenna element 50a so as to transmit and receive; a first current I₁ to and from the first feeding line 52aa, and a second current I2 to and from the second feeding line 52ab. Said feeding device 60a is provided with a first terminal SUM and a second terminal DIFF, which terminals are arranged to be alternately connected to a third feeding line 62a via the two-way switch 64a. The third feeding line 62a of the feeding arrangement 600a is in turn connected to a phase shifter 66a or similar for adding a possible phase increment ψ to the antenna element 50a, which enables a conventional scanning of the antenna lobe in a well-known manner as briefly describe above.

The feeding device 60a of the feeding arrangement 600a is preferably implemented by means of a balun or similar. A balun is a device that is particularly designed to convert between balanced (differential mode) and unbalanced (sum-mode) signals, as is well-known in the art. The balun 60a is typically implemented by means of a small isolation transformer, with the earth ground or chassis ground left floating or unconnected on the balanced side in a well-known manner. The balun 60a may also be implemented by means of e.g. a so-called Magic-T or T-Junction, which is a common and well-known component in the art. However, the invention is not limited to have the balun 60a implemented by means of an isolation transformer, a Magic-T or a T-Junction. On the contrary, the balun may be implemented by means of any other suitable device with the same or similar function as said transformer, Magic-T or T-Junction.

The function of the balun feeding device 60a in FIG. 6A is such that a current provided to the first terminal SUM of the device 60a is substantially equally divided into two currents I₁=I_{sumφ0°}/2 and I₂=I_{sumφ0°}/2, which currents are provided from the device 60a to the antenna element 50a with a 0° phase difference, i.e. the two currents I₁ and I₂ are in phase and the antenna element 50a is therefore excited in a sum-mode, c.f. the currents I₊, I₊ discussed above. Similarly, a current provided to the second terminal DIFF of the device 60a is equally divided into two currents I₁=I_{diffφ180°}/2 and I₂=I_{diff∠0°}/2. However, these two currents are provided from the device 60a to the antenna element 50a with a 180° phase difference, i.e. the two currents I₁ and I₂ are now out of phase and the antenna element 50a is therefore excited in a differential mode, c.f. the currents I_{'}, I₋ discussed above.

It follows that the antenna element 50a can transmit electromagnetic radiation in a sum-mode (unbalanced or end-fire mode) or in a differential mode (balanced or broadside mode) as required by toggling the two-way switch 64aa depending on the direction Φ in which the antenna lobe 55 of the array antenna 50 is intended to radiate.

The expressions below may clarify the function of a feeding device (60a, 60b, 60c . . . 60n).

If the input signal to the DIFF terminal is zero and the input signal to the SUM terminal is I_{SUM}=I₀e^{i(ψn)}, wherein ψₙ represents the phase increment for the antenna element, in question, then:

Iₙ¹=I₀^{′}e^{i(ψn)} [1]

Iₙ²=₀^{′}e^{i(ψn)} [2]

wherein I₀^{′} is the current I₀ adjusted for possible losses etc in the feeding device (60a, 60b, 60c . . . 60n) in question, and wherein Iₙ¹ is the current I₁ for the antenna element in question, and wherein Iₙ² is the current I₂ for the antenna element in question.

If the input signal to the SUM terminal is zero and the input signal to the DIFF terminal is I_{DIFF}=I₀e^{i(ψn)}, wherein ψn represents the phase increment for the antenna element in question, then:

Iₙ¹=I₀^{′}e^{i(ψn+π/2)} [3]

Iₙ²=I₀^{′}e^{i(ψn-π/2)} [4]

wherein I₀^{′} is the current I₀ adjusted for possible losses etc in the feeding device (60a, 60b, 60c . . . 60n) in question, and wherein Iₙ¹ is the current I₁ for the antenna element in question, and wherein Iₙ² is the current I₂ for the antenna element in question.

Naturally, the radiating (transmitting) ability as now described is equally valid for receiving, i.e. the antenna element 50a can receive electromagnetic radiation in a sum-mode (unbalanced or end-fire mode) or in a differential mode (balanced or broadside mode) as required depending on the direction Φ from which the antenna lobe 55 of the array antenna 50 is intended to receive.

However, a balun feeding device 60a or similar as described above is not necessarily required in certain embodiments of a feeding arrangement according to the present invention. This is illustrated In FIG. 6B wherein the balun feeding device 60a has been omitted. Instead, the feeding line 52ab of the dipole 50a has been connected to a power divider/combiner 67a, i.e. not to a balun 60a or similar as in the feeding arrangement 600a in FIG. 6A. Similarly, the feeding line 52aa of the dipole 50a is not connected to a balun 60a or similar as in the feeding arrangement 600a, but to a phase shifter 65a, which in turn is connected to said power divider/combiner 67a. The divider/combiner 67a can e.g. be implemented by means of waveguides or similar as is well known in the art.

If the input signal to the power divider/combiner 67a in FIG. 6B is I_{div/comb}=I₀e^{i(ψn)}, wherein ψn represents the phase increment for the antenna element in question, then:

Iₙ¹=I₀^{′}e^{i(ψn+φ)}=I₀^{′}e^{i(ψn+φ/2)}·e^{i(φ/2)} [5]

Iₙ²=I₀^{′}e^{i(ψn)}=I₀^{′}e^{i(ψn+φ/2)}·e^{-i(φ/2)} [6]

wherein I₀^{′} is the current I₀ adjusted for possible losses etc in the divider/combiner 67a, and wherein φ represents the phase shift added by the phase shifter 65a, and wherein Iₙ¹ is the current I₁ for the antenna element in question, and wherein Iₙ² is the current I₂ for the antenna element in question.

It is clear from equations 5 and 6 that the phase shifter 65a in the feeding arrangement 620a in FIG. 6B enables a substantially continuous alteration of the phase between the two currents 11, 12, e.g. a substantially continuous alteration from a 0° phase difference to a 180° phase difference between the two currents 11, 12. This enables a mix of the sum-mode and the differential mode, i.e. a mix of the unbalanced mode and the balanced mode. In other words, the phase shifter 65a enables a simultaneous utilization of the horizontal elements 51aa, 51ab and the vertical elements 52aa, 52ab in various amounts for transmitting and/or receiving, i.e. the horizontal elements 51aa, 61ab can transmit in a certain amount at the same time as the vertical elements 52aa, 52ab transmit in a certain amount, which also holds for receive.

The invention has now been described by means of exemplifying embodiments. However, it should be emphasized that the invention is by no means limited to the embodiments now described. On the contrary, the invention is intended to comprise all embodiments covered by the scope of the appended claims. For example, the invention is by no means limited to a single row of three collinear dipoles 50a-50c as shown in FIGS. 5A-5B and 6A-6B. On the contrary, an array antenna according to the present invention may comprise anything from two antenna elements to a plurality of antenna elements that are arranged in one or several rows. Further, the antenna elements must not necessarily be arranged in a line or a row. On the contrary, the antenna elements or at least a subset of the antenna elements may be arranged according to other patterns than rows. It should also be emphasised that the description of the substantially horizontal elements 51aa-51cb and the substantially vertical elements 54aa-54cb is applicable mutatis mutandis for both transmitting and receiving.

In addition, the antenna elements must not necessarily be a traditional dipole.

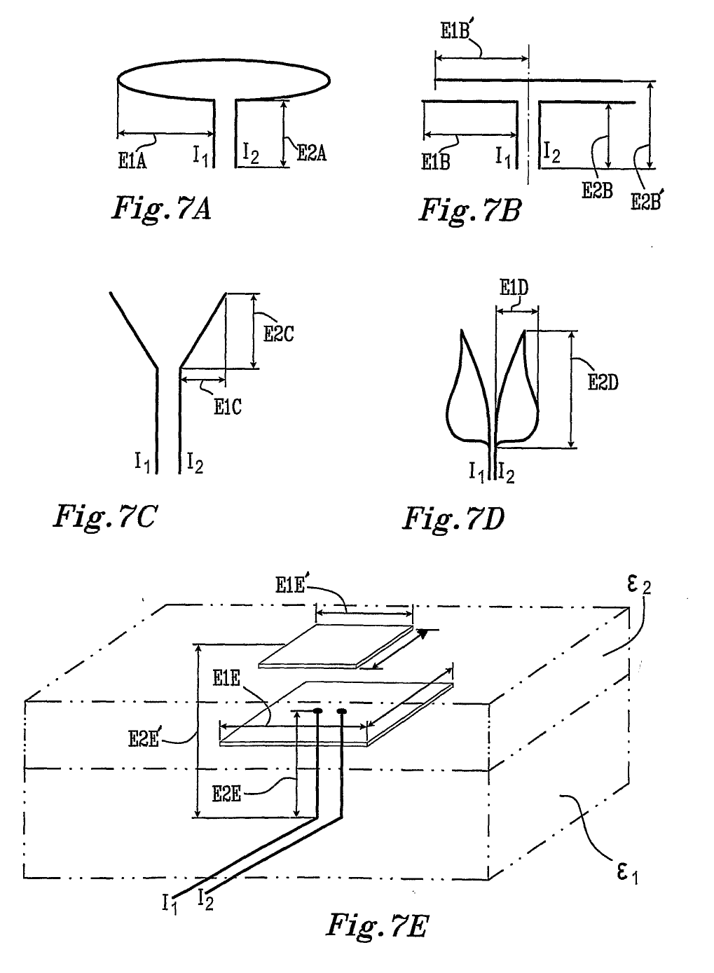

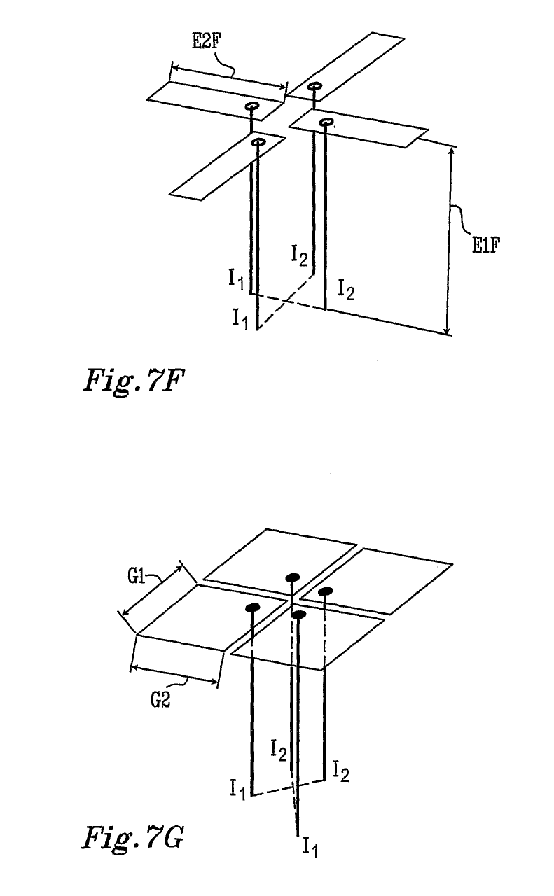

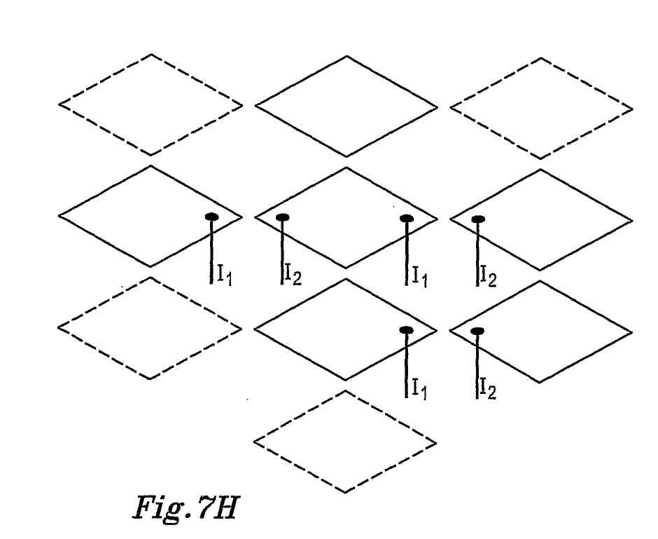

In one embodiment the antenna element may e.g. be a loop antenna as the one schematically illustrated in FIG. 7A. The loop antenna comprises a loop having one ore several turns and extends at least a first distance E1A substantially in parallel to a ground plane (not shown) and at least a second distance E2A substantially perpendicular to said ground plane,

Another embodiment of the invention may utilize a dipole antenna element having a parasitic or resonator element extending in parallel to the horizontal radiating elements, as schematically illustrated in FIG. 7B. The dipole antenna element in FIG. 7B extends at least a first distance E1B substantially in parallel to a ground plane (not shown) and at least a second distance E2B substantially perpendicular to said ground plane, whereas the parasitic element extends a third distance E1B′ substantially in parallel to said ground plane and at least a fourth distance E2B′ substantially perpendicular to said ground plane.

Moreover, the antenna element in an embodiment of the invention may be a dipole that has tilted radiating elements e.g. as the V-shaped antenna element schematically illustrated in FIG. 7C. The V-shaped dipole antenna in FIG. 7C extends at least a first distance E1C substantially in parallel to a ground plane (not shown) and at least a second distance E2C substantially perpendicular to said ground plane.

In addition, the antenna element in an embodiment of the invention may be a so-called Bunny-Ear antenna, e.g. as the bunny ear antenna schematically illustrated in FIG. 7D. The bunny-Ear antenna in FIG. 7D extends at least a first distance E1D substantially in parallel to a ground plane (not shown) and at least a second distance E2D substantially perpendicular to said ground plane.

Furthermore, some embodiments of the invention may utilize an antenna element in the form of a patch antenna, as schematically illustrated in FIG. 7E. The exemplifying patch antenna in FIG. 7E comprises a first substantially flat plate forming an antenna element arranged in a well known manner on a first substrate having a first dielectric constant ε₁, which substrate in turn is arranged on a ground plane (not shown). The patch antenna element extends at least a first distance E1E above and substantially in parallel to said ground plane and it is feed by two substantially parallel feeding lines extending at least a second distance E2E substantially perpendicular to said ground plane. In analogy with the parasitic element shown in FIG. 7B the patch antenna in FIG. 7E may also have a parasitic element arranged on a second substrate having a second dielectric constant F2. The parasitic element may e.g. be a substantially flat plate extending a third distance E1E′ substantially in parallel to said ground plane and at least a fourth distance E2E′ substantially perpendicular to said ground plane.

The antenna element in an embodiment of the invention may also be a double polarized antenna element, e.g. as the double polarized antenna element shown in FIG. 7F comprising two dipoles displaced 90° with respect to each other, as is well known in connection with double polarized antenna elements. The dipole antenna may e.g. based on a dipole antenna element such as the dipoles 50a-50c shown in FIGS. 5A-5B. Hence, the double polarized antenna element in FIG. 7F extends at least a first distance E1F above and substantially in parallel to a ground plane (not shown) and then at least a second distance E2F substantially perpendicular to said ground plane.

FIG. 7G is schematic illustration of another exemplifying double polarized embodiment of a dipole antenna element known as the four-square antenna element. The four-square antenna element comprises two dipoles each comprising two substantially square-shaped plates. The four plates are arranged in a square formation so that the dipoles are displaced 90° with respect to each other. A feeding probe is provided at the corner of each square plate closest to the center of the square formation. The plates are arranged at least a first distance above and substantially parallel to a ground plane (not shown) and then at least a second distance substantially perpendicular to said ground plane.

FIG. 7H is a schematic illustration of a patch element array antenna with a corner feeding arrangement. The patch element may e.g. be similar to the patch element schematically illustrated in FIG. 7E. The patch elements in FIG. 7H are arranged in a chessboard pattern, wherein each feeding probe pair carrying the currents 11, 12 connects to the closely spaced corners of two neighboring patches. This embodiment may also be provided with additional probe pairs enabling double polarization.

Any of the antenna elements discussed above can be combined with one or several dielectric layers above and/or below the element such as to modify the SUM and DIFF mode scan patterns.

### REFERENCE SIGNS

10 Dipole
11a Radiating Element
11b Radiating Element
12a Feeding Line
12b Feeding Line
20 Monopole
21 Vertical Radiating Element
23 Horizontal Ground Plane
30 Broadside Array Antenna
30a Dipole
30b Dipole
30c Dipole
31aa Radiating Element
31ab Radiating Element
31ba Radiating Element
31bb Radiating Element
31ca Radiating Element
31cb Radiating Element
32aa Feeding Line
32ab Feeding Line
32ba Feeding Line
32bb Feeding Line
32ca Feeding Line
32cb Feeding Line
33 Substrate
35 Main Lobe of Broadside Array
35′ Main Lobe of Broadside Array
40 End-Fire Array Antenna
40a Monopole
40b Monopole
40c Monopole
40d Monopole
40e Monopole
40f Monopole
41a Radiating Element
41b Radiating Element
41c Radiating Element
41d Radiating Element
41e Radiating Element
41f Radiating Element
42a Feeding Line
42b Feeding Line
42c Feeding Line
42d Feeding Line
42e Feeding Line
42f Feeding Line
43 Ground Plane
45 Main Lobe of End-Fire Antenna
45′ Main Lobe of End-Fire Antenna
50 Array Antenna
50a Dipole
50b Dipole
50c Dipole
51aa Horizontal Radiating Element
51ab Horizontal Radiating Element
51ba Horizontal Radiating Element
51bb Horizontal Radiating Element
51ca Horizontal Radiating Element
51cb Horizontal Radiating Element
52aa Feeding Line
52ab Feeding Line
52ba Feeding Line
52bb Feeding Line
52ca Feeding Line
52cb Feeding Line
53 Ground Plane
54aa Vertical Radiating Element
54ab Vertical Radiating Element
54ba Vertical Radiating Element
54bb Vertical Radiating Element
54ca Vertical Radiating Element
54cb Vertical Radiating Element
55 Main Lobe of Broadside Array
55′ Main Lobe of End-Fire Array
55″ Main Lobe of End-Fire Array
56aa Upper Distributing End
56ab Upper Distributing End
56ba Upper Distributing End
56bb Upper Distributing End
56ca Upper Distributing End
56cb Upper Distributing End
57aa Lower Feeding End
57ab Lower Feeding End
57ba Lower Feeding End
57bb Lower Feeding End
57ca Lower Feeding End
57cb Lower Feeding End
60a Feeding Device (Balun)
60c Feeding Device (Balun)
62a Feeding Line
62c Feeding Line
64a Two-Way Switch
64c Two-Way Switch
65a Phase Shifter (Mode Shift)
66c Phase Shifter (Mode Shift)
66a Phase Shifter (Main Lobe Scanning)
66c Phase Shifter (Main Lobe Scanning)
67a Power Divider/Combiner
67c Power Divider/Combiner
600a Feeding Arrangement
600c Feeding Arrangement
620a Feeding Arrangement
620c Feeding Arrangement
E1 Extension, Radiating Element
E2 Extension, Radiating Element
DP1 Horizontal Dipole Axis
DP2 Horizontal Dipole Axis
DP3 Horizontal Dipole Axis
MP Vertical Monopole Axis
MPa Vertical Monopole Axis
MPb Vertical Monopole Axis
MPc Vertical Monopole Axis
MPd Vertical Monopole Axis
MPe Vertical Monopole Axis
MPf Vertical Monopole Axis
MPaa Vertical “Monopole” Axis
MPab Vertical “Monopole” Axis
MPba Vertical “Monopole” Axis
MPbb Vertical “Monopole” Axis
MPca Vertical “Monopole” Axis
MPcb Vertical “Monopole” Axis
L1 Line/Row of Monopoles
L2 Line/Row of Monopoles

1-13. (canceled)

14. An array antenna comprising:
a region of reference potential and a spatially extended collection of at least two antenna elements capable of being at least partly balanced driven and at least partly unbalanced driven, wherein said antenna elements further comprise:
a first radiating element coupled to a first port, and a second radiating element coupled to a second port, which radiating elements are arranged substantially adjacent and parallel to each other so as to extend at least a first distance approximately perpendicularly from said region, and
a radiating arrangement coupled to said first and second radiating elements so as to extend at least a second distance above and approximately parallel to said region.

15. The array antenna according to claim 14, wherein said radiating arrangement comprises a third radiating element coupled to said first radiating element, and a fourth radiating element coupled to said second radiating element.

16. The array antenna according to claim 14, wherein said radiating arrangement comprises a substantially continuous radiating element connected to said first radiating element and to said second radiating element.

17. The array antenna according to claim 15, wherein said third and fourth radiating element is selected from a group of elements consisting of: substantially straight thread shaped or cylindrically shaped elements, substantially loop shaped elements, or substantially flat plate elements.

18. The array antenna according to claim 14, wherein the first and second ports of each antenna element are coupled to a feeding arrangement wherein the feeding arrangement is arranged to vary the phase difference φ between a first signal communicated between the first port and the feeding arrangement and a second signal communicated between the second port and the feeding arrangement.

19. The array antenna according to claim 18, wherein the feeding arrangement comprises a device arranged so that a signal (IQ) communicated with a first terminal of the device is divided with a first substantially fixed phase difference φ−j between said first signal and said second signal and a signal communicated with a second terminal of the device is divided with a second substantially fixed phase difference between said first signal and said second signal.

20. The array antenna according to claim 19, wherein the first device terminal and the second device terminal is connected to a switch, which in a first position enables the signal to be communicated with the first device terminal and in a second position enables the signal to be communicated with the second device terminal.

21. The array antenna according to claim 18, wherein the feeding arrangement comprises a distribution arrangement coupled to said first and second ports and to a feeding line and being arranged so as to combine signals received from said ports into said feeding line and to divide a signal received from said feeding line between said ports and at least one phase shifter coupled between at least one of said ports and said distribution arrangement so as to varying the phase φ of a signal communicated between that port and the distribution arrangement.

22. A method for transmitting or receiving by means of an array antenna having a region of reference potential and a spatially extended collection of at least two antenna elements capable of being at least partly balanced driven and at least partly unbalanced driven, wherein said antenna elements have a first radiating element coupled to a first port and a second radiating element coupled to a second port, which radiating elements are arranged substantially adjacent and parallel to each other so as to extend at least a first distance approximately perpendicularly from said region and a radiating arrangement coupled to said first and second radiating elements so as to extend at least a second distance above and approximately parallel to said region said method including the step of:
transmitting or receiving electromagnetic radiation by the antenna elements in a variable direction by varying the phase difference φ between a first signal (Jⱼ) communicated with the first port of the antenna element and a second signal (Z₂) communicated with the second port.

23. The method according to claim 22, wherein the phase difference φ is accomplished by utilizing a feeding arrangement coupled to the first and second port of each antenna element wherein the feeding arrangement is varying the phase difference φ between: a first signal communicated between said first port and said feeding arrangement and a second signal communicated between said second port and said feeding arrangement.

24. The method according to claim 23, wherein the feeding arrangement comprises a device arranged so that a signal communicated with a first terminal of the device is divided with a first substantially fixed phase difference φ between said first signal and said second signal, and a signal communicated with a second terminal of the device is divided with a second substantially fixed phase difference between said first signal and said second signal.

25. The method according to claim 23, wherein the first device terminal and the second device terminal is coupled to a switch which is operated so that in a first position the signal is communicated with the first device terminal and so that in a second position the signal is communicated with the second device terminal.

26. The method according to claim 23, wherein the phase difference φ is accomplished by utilizing a feeding arrangement wherein a distribution arrangement is connected to said first and second ports and to a feeding line and being arranged so as to combine signals received from said ports into said feeding line and to divide a signal received from said feeding line between said ports, and
at least one phase shifter is coupled between at least one of said ports and said distribution arrangement so as to vary the phase (p of a signal communicated between that port and the distribution arrangement.
